(19) United States
(12) Patent Application Publication
(10) Pub. No.: US 2025/0048200 A1
(43) Pub. Date: Feb. 6, 2025

(54) UE-BASED TIMING ADVANCE MEASUREMENT IN WIRELESS SYSTEMS

(71) Applicant: Samsung Electronics Co., Ltd., Suwon-si (KR)

(72) Inventors: Shiyang Leng, Allen, TX (US); Anil Agiwal, McKinney, TX (US); Emad Nader Farag, Flanders, NJ (US)

(21) Appl. No.: 18/776,161

(22) Filed: Jul. 17, 2024

Related U.S. Application Data
(60) Provisional application No. 63/530,601, filed on Aug. 3, 2023.
(60) Provisional application No. 63/537,034, filed on Sep. 7, 2023.
(60) Provisional application No. 63/645,233, filed on May 10, 2024.
(60) Provisional application No. 63/647,711, filed on May 15, 2024.

(51) Int. Cl. H04W 36/00; H04W 56/00

(52) U.S. Cl. CPC H04W 36/0072; H04W 56/0045

(57) ABSTRACT

A User equipment (UE) transmits, to a base station, a capability information indicating whether the UE supports UE-based timing advance measurement, and receives, from the base station, an indication indicating whether UE-based timing advance measurement is enabled for a candidate cell for layer 1/layer 2 triggered mobility (LTM). The UE configures UE-based timing advance measurement for the candidate cell for LTM based on the indication, and performs UE-based timing advance measurement for the candidate cell for LTM. The UE receives a cell switch command from the base station. When a valid timing advance is not included in the cell switch command, the UE switches to the candidate cell for LTM by applying a timing advance measured by the UE. When the valid timing advance is included in the cell switch command, the UE switches to the candidate cell for LTM by applying the valid timing advance.

### CROSS-REFERENCE TO RELATED APPLICATIONS

This application claims the benefit of priority from U.S. Provisional Application No. 63/530,601 entitled “UE-ESTIMATED TIMING ADVANCE FOR MOBILITY,” filed Aug. 3, 2023; U.S. Provisional Application No. 63/537,034 entitled “TIMING ADVANCE REPORT FOR AIR-TO-GROUND NETWORK,” filed Sep. 7, 2023; U.S. Provisional Application No. 63/645,233 entitled “TIMING ADVANCE REPORT FOR AIR-TO-GROUND NETWORK,” filed May 10, 2024; and U.S. Provisional Application No. 63/647,711 entitled “TIMING ADVANCE REPORT FOR AIR-TO-GROUND NETWORK,” filed May 15, 2024, all which are incorporated herein by reference in their entirety.

### TECHNICAL FIELD

This disclosure relates generally to a wireless communication system, and more particularly to, for example, but not limited to, mobility in a wireless communication system.

### BACKGROUND

Mobility management operations including network handovers represent a pivotal aspect of any wireless communication system. These systems include, for example, LTE and 5G New Radio (NR), and upcoming technologies currently coined “6G”. Mobility is presently controlled by the network with user equipment (UE) assistance to maintain optimal connection quality. The network may hand over the UE to a target cell with superior signal quality.

The inclusion of enhanced broadband mechanisms requiring high speeds and low latencies has necessitated more sophisticated handover mechanisms. Accordingly, conditional handovers (CHOs) and separately, layer 1/layer 2 triggered mobility (LTM) have been introduced to provide additional conditions for specific networks or slices thereof to increase handover speed. The use of these enhancements, however, introduces latencies of its own, at least because the network needs to conduct several data exchanges with the UE during the handover process. The initiation of a prospective handover triggered by the network consequently introduces latencies, signaling overhead, and interruption times of its own.

The description set forth in the background section should not be assumed to be prior art merely because it is set forth in the background section. The background section may describe aspects or embodiments of the present disclosure.

### SUMMARY

An aspect of the present disclosure provides a user equipment (UE) for facilitating communication in a wireless network. The UE comprises a transceiver configured to: transmit, to a base station (BS), a capability information indicating whether the UE supports UE-based timing advance measurement; and receive, from the BS, an indication indicating that UE-based timing advance measurement is enabled for a candidate cell for layer 1/layer 2 triggered mobility (LTM). The UE comprises a processor configured to the transceiver. The processor is configured to: configure UE-based timing advance measurement for the candidate cell for LTM based on the indication; and perform UE-based timing advance measurement for the candidate cell for LTM. The transceiver is further configured to receive, from the BS, a cell switch command. The processor is further configured to: when a valid timing advance is not included in the cell switch command, switch to the candidate cell for LTM by applying a timing advance measured by the UE; and when the valid timing advance is included in the cell switch command, switch to the candidate cell for LTM by applying the valid timing advance.

In some embodiments, the processor is further configured to start a time alignment timer associated with a timing advance group.

In some embodiments, the capability information indicates whether the UE supports UE-based timing advance measurement per frequency band.

In some embodiments, the processor is further configured to skip random access to switch to the candidate cell for LTM when a valid timing advance is available.

In some embodiments, the processor is further configured to perform random access to switch to the candidate cell for LTM when a valid timing advance is not available.

In some embodiments, the transceiver is further configured to receive, from the BS, a reference timing advance for UE-based timing advance measurement.

In some embodiments, the processor is further configured to: determine that the timing advance measured by the UE is valid when the reference timing advance is valid; and determine that the timing advance measured by the UE is invalid when the reference timing advance is invalid.

In some embodiments, the transceiver is further configured to receive, from the BS, a timing advance estimation timer that controls validity of timing advance estimated based on UE-based timing advance measurement.

An aspect of the present disclosure provides a method performed by a user equipment (UE) for facilitating wireless communication in a wireless network. The method comprising: transmitting, to a base station (BS), a capability information indicating whether the UE supports UE-based timing advance measurement; receiving, from the BS, an indication indicating that UE-based timing advance measurement is enabled for a candidate cell for layer 1/layer 2 triggered mobility (LTM); configuring UE-based timing advance measurement for the candidate cell for LTM based on the indication; and performing UE-based timing advance measurement for the candidate cell for LTM; receiving a cell switch command from the BS. The method comprises switching to the candidate cell for LTM by applying a timing advance measured by the UE, when a valid timing advance is not included in the cell switch command. The method comprises switching to the candidate cell for LTE by applying the valid timing advance, when the valid timing advance is included in the cell switch command,

In some embodiments, the method further comprises initiating a time alignment timer associated with a timing advance group.

In some embodiments, the capability information indicates whether the UE supports UE-based timing advance measurement per frequency band.

In some embodiments, the method further comprises skipping random access to switch to the candidate cell for LTM when a valid timing advance is available.

In some embodiments, the method further comprises performing random access to switch to the candidate cell for LTM when a valid timing advance is not available.

In some embodiments, the method further comprises receiving, from the BS, a reference timing advance for UE-based timing advance measurement.

In some embodiments, the method further comprises: determining that the timing advance measured by the UE is valid when the reference timing advance is valid; and determining that the timing advance measured by the UE is invalid when the reference timing advance is invalid.

In some embodiments, the method further comprises receiving, from the BS, a timing advance estimation timer that controls validity of timing advance estimated based on UE-based timing advance measurement.

An aspect of the present disclosure provides a base station (BS) facilitating communication in a wireless network. The BS comprises a transceiver configured to: receive, from a user equipment (UE), a capability information indicating whether the UE supports UE-based timing advance measurement; transmit, to the UE, an indication indicating that UE-based timing advance measurement is enabled for a candidate cell for layer 1/layer 2 triggered mobility (LTM); and transmit, to the UE, a cell switch command that triggers cell switching to the candidate cell for LTM.

In some embodiments, no valid timing advance in the cell switch command indicates that a timing advance measured by the UE is applied to switch to the candidate cell for LTM.

In some embodiments, the capability information indicates whether the UE supports UE-based timing advance measurement per frequency band.

In some embodiments, the transceiver is further configured to transmit, to the UE, i) a reference timing advance for UE-based timing advance measurement and ii) a timing advance estimation timer that controls validity of timing advance estimated based on UE-based timing advance measurement.

### BRIEF DESCRIPTION OF THE DRAWINGS

FIG. 1 shows an example of a wireless network in accordance with an embodiment.

FIG. 2A shows an example of a wireless transmit path in accordance with an embodiment.

FIG. 2B shows an example of a wireless receive path in accordance with an embodiment.

FIG. 3A shows an example of a user equipment (“UE”) in accordance with an embodiment.

FIG. 3B shows an example of a base station (“BS”) in accordance with an embodiment.

FIG. 4 shows an example signaling diagram of a conditional handover procedure.

FIG. 5 shows an example process for UE-based timing advance measurement in mobility in accordance with an embodiment.

FIG. 6 shows another example process for UE-based timing advance measurement in LTM in accordance with an embodiment.

FIG. 7 shows an example of timing advance report MAC CE in accordance with an embodiment.

FIG. 8 shows another example of timing advance report MAC CE in accordance with an embodiment.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in numerous ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied using a multitude of different approaches. The examples in this disclosure are based on the current 5G NR systems, 5G-Advanced (5G-A) and further improvements and advancements thereof and to the upcoming 6G communication systems. However, under various circumstances, the described embodiments may also be implemented in any device, system or network that is capable of transmitting and receiving radio frequency (RF) signals according to other technologies, such as the 3G and 4G systems, or further implementations thereof. For example, the principles of the disclosure may apply to Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), enhancements of 5G NR, AMPS, or other known signals that are used to communicate within a wireless, cellular or IoT network, such as one or more of the above-described systems utilizing 3G, 4G, 5G, 6G or further implementations thereof. The technology may also be relevant to and may apply to any of the existing or proposed IEEE 802.11 standards, the Bluetooth standard, and other wireless communication standards.

Wireless communications like the ones described above have been among the most commercially acceptable innovations in history. Setting aside the automated software, robotics, machine learning techniques, and other software that automatically use these types of communication devices, the sheer number of wireless or cellular subscribers continues to grow. A little over a year ago, the number of subscribers to the various types of communication services had exceeded five billion. That number has long since been surpassed and continues to grow quickly. The demand for services employing wireless data traffic is also rapidly increasing, in part due to the growing popularity among consumers and businesses of smart phones and other mobile data devices, such as tablets, “note pad” computers, net books, eBook readers, and dedicated machine-type devices. It should be self-evident that, to meet the high growth in mobile data traffic and support new applications and deployments, improvements in radio interface efficiency and coverage are of paramount importance.

To continue to accommodate the growing demand for the transmission of wireless data traffic having dramatically increased over the years, and to facilitate the growth and sophistication of so-called “vertical applications” (that is, code written or produced in accordance with a user's or entities' specific requirements to achieve objectives unique to that user or entity, including enterprise resource planning and customer relationship management software, for example), 5G communication systems have been developed and are currently being deployed commercially. 5G Advanced, as defined in 3GPP Release 18, is yet a further upgrade to aspects of 5G and has already been introduced as an optimization to 5G in certain countries. Development of 5G Advanced is well underway. The development and enhancements of 5G also can accord processing resources greater overall efficiency, including, by way of example, in high-intensive machine learning environments involving precision medical instruments, measurement devices, robotics, and the like. Due to 5G and its expected successor technologies, access to one or more application programming interfaces (APIs) and other software routines by these devices are expected to be more robust and to operate at faster speeds.

Among other advantages, 5G can be implemented to include higher frequency bands, including in particular 28 GHz or 60 GHz frequency bands. More generally, such frequency bands may include those above 6 GHz bands. A key benefit of these higher frequency bands are potentially significantly superior data rates. One drawback is the requirement in some cases of line-of-sight (LOS), the difficulty of higher frequencies to penetrate barriers between the base station and UE, and the shorter overall transmission range. 5G systems rely on more directed communications (e.g., using multiple antennas, massive multiple-input multiple-output (MIMO) implementations, transmit and/or receive beamforming, temporary power increases, and like measures) when transmitting at these mmWave (mmW) frequencies. In addition, 5G can beneficially be transmitted using lower frequency bands, such as below 6 GHz, to enable more robust and distant coverage and for mobility support (including handoffs and the like). As noted above, various aspects of the present disclosure may be applied to 5G deployments, to 6G systems currently under development, and to subsequent releases. The latter category may include those standards that apply to the THz frequency bands. To decrease propagation loss of the radio waves and increase transmission distance. as noted in part, emerging technologies like MIMO, Full Dimensional MIMO (FD-MIMO), array antenna, digital and analog beamforming, large scale antenna techniques and other technologies are discussed in the various 3GPP-based standards that define the implementation of 5G communication systems.

In addition, in 5G communication systems, development for system network improvement is underway or has been deployed based on advanced small cells, cloud Radio Access Networks (RANs), ultra-dense networks, device-to-device (D2D) communication, wireless backhaul, moving networks, cooperative communication, Coordinated Multi-Points (CoMP), reception-end interference cancellation, and the like. As exemplary technologies like neural-network machine learning, unmanned or partially-controlled electric vehicles, or hydrogen-based vehicles begin to emerge, these 5G advances are expected to play a potentially significant role in their respective implementations. Further advanced access technologies under the umbrella of 5G that have been developed or that are under development include, for example: advanced coding modulation (ACM) schemes using Hybrid frequency-shift-keying (FSK), frequency quadrature amplitude modulation (FQAM) and sliding window superposition coding (SWSC); and advanced access technologies using filter bank multi-carrier (FBMC), non-orthogonal multiple access (NOMA), and sparse code multiple access (SCMA).

Also under development are the principles of the 6G technology, which may roll out commercially at the end of decade or even earlier. 6G systems are expected to take most or all the improvements brought by 5G and improve them further, as well as to add new features and capabilities. It is also anticipated that 6G will tap into uncharted areas of bandwidth to increase overall capacities. As noted, principles of this disclosure are expected to apply with equal force to 6G systems, and beyond.

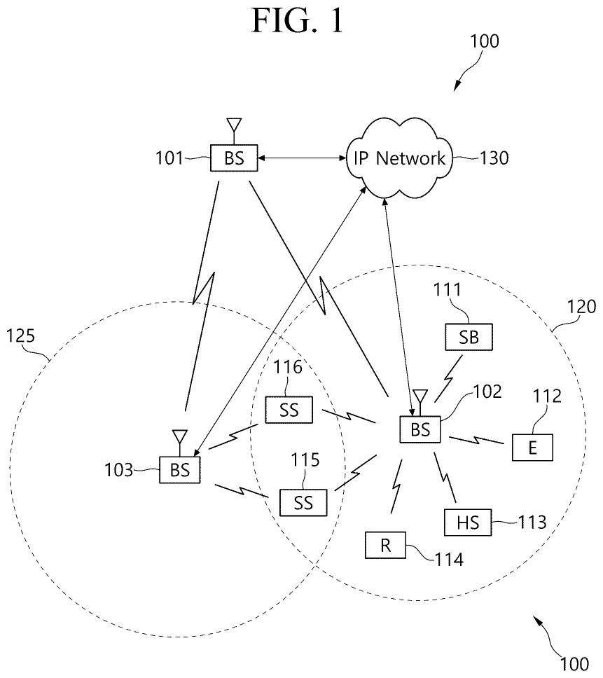

FIG. 1 shows an example of a wireless network 100 in accordance with an embodiment. The embodiment of the wireless network 100 shown in FIG. 1 is for purposes of illustration only. Other embodiments of the wireless network 100 can be used without departing from the scope of this disclosure. Initially it should be noted that the nomenclature may vary widely depending on the system. For example, in FIG. 1, the terminology “BS” (base station) may also be referred to as an eNodeB (eNB), a gNodeB (gNB), or at the time of commercial release of 6G, the BS may have another name. For the purposes of this disclosure, BS and gNB are used interchangeably. Thus, depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Referring back to FIG. 1, the network 100 includes BSs (or gNBs) 101, 102, and 103. BS 101 communicates with BS 102 and BS 103. BSs may be connected by way of a known backhaul connection, or another connection method, such as a wireless connection. BS 101 also communicates with at least one Internet Protocol (IP)-based network 130. Network 130 may include the Internet, a proprietary IP network, or another network.

Similarly, depending on the network 100 type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used interchangeably with “subscriber station” in this patent document to refer to remote wireless equipment that wirelessly accesses a gNB, whether the UE is a mobile device (such as a mobile telephone or smartphone) or is normally considered a stationary device (such as a desktop computer, vending machine, appliance, or any device with wireless connectivity compatible with network 100). With continued reference to FIG. 1, BS 102 provides wireless broadband access to the IP network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The BS 103 provides wireless broadband access to IP network 130 for a second plurality of UEs within a coverage area 125 of the BS 103. The second plurality of UEs includes the UE 115 and the UE 116, which are in both coverage areas 120 and 125. In some embodiments, one or more of the BSs 101-103 may communicate with each other and with the UEs 111-116 using 6G, 5G, long-term evolution (LTE), LTE-A, WiMAX, or other advanced wireless communication techniques.

In FIG. 1, as noted, dotted lines show the approximate extents of the coverage area 120 and 125 of BSs 102 and 103, respectively, which are shown as approximately circular for the purposes of illustration and explanation. It should be clearly understood that coverage areas associated with APs, such as the coverage areas 120 and 125, may have other shapes, including irregular shapes, depending on the configuration of the BSs. Although FIG. 1 illustrates one example of a wireless network 100, various changes may be made to FIG. 1. For example, the wireless network 100 can include any number of BSs/gNBs and any number of UEs in any suitable arrangement. Also, the BS 101 can communicate directly with any number of UEs and provide those UEs with wireless broadband access to IP network 130. Similarly, each BS 102 or 103 can communicate directly with IP network 130 and provide UEs with direct wireless broadband access to the network 130. Further, gNB 101, 102, and/or 103 can provide access to other or additional external networks, such as external telephone networks or other types of data networks.

It will be appreciated that in 5G systems, the BS 101 may include multiple antennas, multiple radio frequency (RF) transceivers, transmit (TX) processing circuitry, and receive (RX) processing circuitry. The BS 101 also may include a controller/processor, a memory, and a backhaul or network interface. The RF transceivers may receive, from the antennas, incoming RF signals, such as signals transmitted by UEs in network 100. The RF transceivers may down-convert the incoming RF signals to generate intermediate (IF) or baseband signals. The IF or baseband signals are sent to the RX processing circuitry, which generates processed baseband signals by filtering, decoding, and/or digitizing the baseband or IF signals. The RX processing circuitry transmits the processed baseband signals to the controller/processor for further processing.

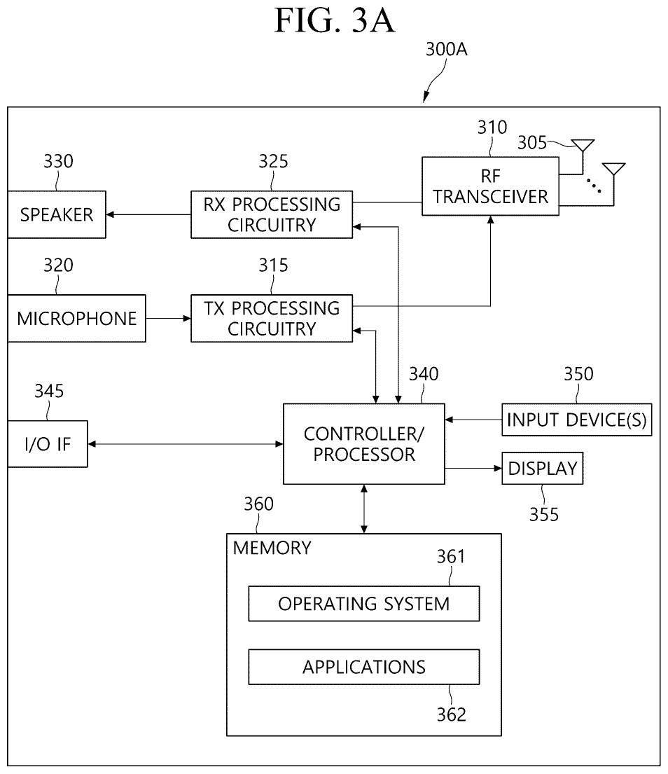

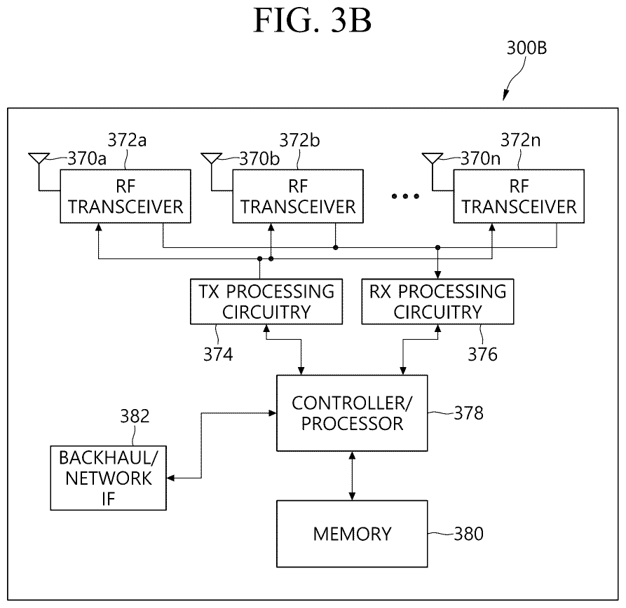

As shown with reference to FIG. 3B, below, the TX processing circuitry 374 receives analog or digital data (such as voice data, web data, e-mail, or interactive video game data) from the controller/processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-convert the baseband or IF signals to RF signals that are transmitted via the antennas 370a-370n.

The controller/processor can include one or more processors or other processing devices that control the overall operation of the BS 101 (FIG. 1). For example, the controller/processor may control the reception of uplink signals and the transmission of downlink signals by the UEs, the RX processing circuitry, and the TX processing circuitry in accordance with well-known principles. The controller/processor may support additional functions as well, such as more advanced wireless communication functions. For instance, the controller/processor may support beamforming or directional routing operations in which outgoing signals from multiple antennas are weighted differently to effectively steer the outgoing signals in a desired direction. The controller/processor may also support OFDMA operations in which outgoing signals may be assigned to different subsets of subcarriers for different recipients (e.g., different UEs 111-114). Any of a wide variety of other functions may be supported in the BS 101 by the controller/processor including a combination of MIMO and OFDMA in the same transmit opportunity. In some embodiments, the controller/processor may include at least one microprocessor or microcontroller. The controller/processor is also capable of executing programs and other processes resident in the memory, such as an OS. The controller/processor can move data into or out of the memory as required by an executing process.

The controller/processor is also coupled to the backhaul or network interface. The backhaul or network interface allows the BS 101 to communicate with other BSs, devices or systems over a backhaul connection or over a network. The interface may support communications over any suitable wired or wireless connection(s). For example, the interface may allow the BS 101 to communicate over a wired or wireless local area network or over a wired or wireless connection to a larger network (such as the Internet). The interface may include any suitable structure supporting communications over a wired or wireless connection, such as an Ethernet or RF transceiver. The memory is coupled to the controller/processor. Part of the memory may include a RAM, and another part of the memory may include a Flash memory or other ROM.

For purposes of this disclosure, the processor may encompass not only the main processor, but also other hardware, firmware, middleware, or software implementations that may be responsible for performing the various functions. In addition, the processor's execution of code in a memory may include multiple processors and other elements and may include one or more physical memories. Thus, for example, the executable code or the data may be located in different physical memories, which embodiment remains within the spirit and scope of the present disclosure.

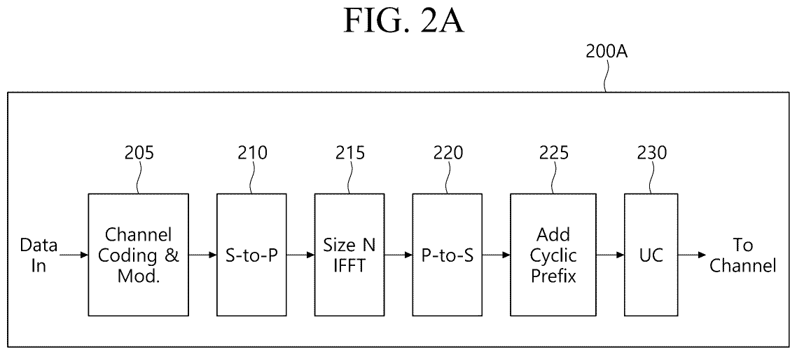

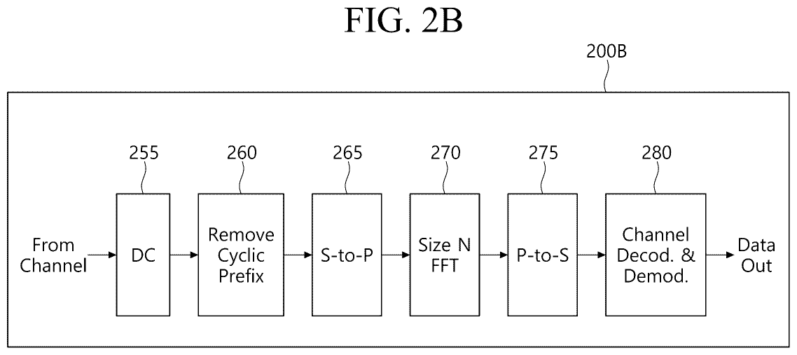

FIG. 2A shows an example of a wireless transmit path 200A in accordance with an embodiment. FIG. 2B shows an example of a wireless receive path 200B in accordance with an embodiment. In the following description, a transmit path 200A may be implemented in a gNB/BS (such as BS 102 of FIG. 1), while a receive path 200B may be implemented in a UE (such as UE 111 (SB) of FIG. 1). However, it will be understood that the receive path 200B can be implemented in a BS and that the transmit path 200A can be implemented in a UE. In some embodiments, the receive path 200B is configured to support the codebook design and structure for systems having 2D antenna arrays as described in some embodiments of the present disclosure. That is to say, each of the BS and the UE include transmit and receive paths such that duplex communication (such as a voice conversation) is made possible.

The transmit path 200A includes a channel coding and modulation block 205 for modulating and encoding the data bits into symbols, a serial-to-parallel (S-to-P) conversion block 210, a size N Inverse Fast Fourier Transform (IFFT) block 215 for converting N frequency-based signals back to the time domain before they are transmitted, a parallel-to-serial (P-to-S) block 220 for serializing the parallel data block from the IFFT block 215 into a single datastream (noting that BSs/UEs with multiple transmit paths may each transmit a separate datastream), an add cyclic prefix block 225 for appending a guard interval that may be a replica of the end part of the orthogonal frequency domain modulation (OFDM) symbol (or whatever modulation scheme is used) and is generally at least as long as the delay spread to mitigate effects of multipath propagation. Alternatively, the cyclic prefix may contain data about a corresponding frame or other unit of data. An up-converter (UC) 230 is next used for modulating the baseband (or in some cases, the intermediate frequency (IF)) signal onto the carrier signal to be used as an RF signal for transmission across an antenna.

The receive path 200B essentially includes the opposite circuitry and includes a down-converter (DC) 255 for removing the datastream from the carrier signal and restoring it to a baseband (or in other embodiments an IF) datastream, a remove cyclic prefix block 260 for removing the guard interval (or removing the interval of a different length), a serial-to-parallel (S-to-P) block 265 for taking the datastream and parallelizing it into N datastreams for faster operations, a multi-input size N Fast Fourier Transform (FFT) block 270 for converting the N time-domain signals to symbols into the frequency domain, a parallel-to-serial (P-to-S) block 275 for serializing the symbols, and a channel decoding and demodulation block 280 for decoding the data and demodulating the symbols into bits using whatever demodulating and decoding scheme was used to initially modulate and encode the data in reference to the transmit path 200A.

As a further example, in the transmit path 200A of FIG. 2A, the channel coding and modulation block 205 receives a set of information bits, applies coding (such as a low-density parity check (LDPC) coding), and modulates the input bits (such as with Quadrature Phase Shift Keying (QPSK), Quadrature Amplitude Modulation (QAM), Orthogonal Frequency Domain Multiple Access (OFDMA), or other current or future modulation schemes) to generate a sequence of frequency-domain modulation symbols. The serial-to-parallel block 210 converts (such as de-multiplexes) the serial modulated symbols to parallel data to generate N parallel symbol streams, where as noted, N is the IFFT/FFT size used in the BS 102 and the UE 116 FIG. 1). The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 to generate a serial time-domain signal. The add cyclic prefix block 225 inserts a cyclic prefix to the time-domain signal. The up-converter 230 modulates (such as up-converts) the output of the add cyclic prefix block 225 from baseband (or in other embodiments, an intermediate frequency IF) to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116 (FIG. 1). The down-converter 255 (for example, at UE 116) down-converts the received signal to a baseband or IF frequency, and the remove cyclic prefix block 260 removes the cyclic prefix to generate a serial time-domain baseband signal. The serial-to-parallel block 265 converts or multiplexes the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream. The data stream may then be portioned and processed accordingly using a processor and its associated memory(ies). Each of the BSs 101-103 of FIG. 1 may implement a transmit path 200A that is analogous to transmitting in the downlink to UEs 111-116, Likewise, each of the BSs 101-103 may implement a receive path 200B that is analogous to receiving in the uplink from UEs 111-116. Similarly, to realize bidirectional signal execution, each of UEs 111-116 may implement a transmit path 200A for transmitting in the uplink to BSs 101-103 and each of UEs 111-116 may implement a receive path 200B for receiving in the downlink from gNBs 101-103. In this manner, a given UE may exchange signals bidirectionally with a BS within its range, and vice versa.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation. In addition, although described as using FFT and IFFT, this exemplary implementation is by way of illustration only and should not be construed to limit the scope of this disclosure. For example, other types of transforms, such as Discrete Fourier Transform (DFT) and Inverse Discrete Fourier Transform (IDFT) functions, can be used in lieu of the FFT/IFFT. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions. Additionally, although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network. For example, the functions performed by the modules in FIGS. 2A and 2B may be performed by a processor executing the correct code in memory corresponding to each module.

FIG. 3A shows an example of a user equipment (“UE”) 300A (which may be UE 116 in FIG. 1, for example, or another UE) in accordance with an embodiment. It should be underscored that the embodiment of the UE 300A illustrated in FIG. 3A is for illustrative purposes only, and the UEs 111-116 of FIG. 1 can have the same or similar configuration. However, UEs come in a wide variety of configurations, and the UE 300A of FIG. 3A does not limit the scope of this disclosure to any particular implementation of a UE. Referring now to the components of FIG. 3A, the UE 300A includes an antenna 305 (which may be a single antenna or an array or plurality thereof in other UEs), a radio frequency (RF) transceiver 310, transmit (TX) processing circuitry 315 coupled to the RF transceiver 310, a microphone 320, and receive (RX) processing circuitry 325. The UE 300A also includes a speaker 330 coupled to the receive processing circuitry 325, a main processor 340, an input/output (I/O) interface (IF) 345 coupled to the processor 340, a keypad (or other input device(s)) 350, a display 355, and a memory 360 coupled to the processor 340. The memory 360 includes a basic operating system (OS) program 361 and one or more applications 362, in addition to data. In some embodiments, the display 355 may also constitute an input touchpad and in that case, it may be bidirectionally coupled with the processor 340.

The RF transceiver may include more than one transceiver, depending on the sophistication and configuration of the UE. The RF transceiver 310 receives from antenna 305, an incoming RF signal transmitted by a BS of the network 100. The RF transceiver sends and receives wireless data and control information. The RF transceiver is operable coupled to the processor 340, in this example via TX processing circuitry 315 and RF processing circuitry 325. The RF transceiver 310 may thereupon down-convert the incoming RF signal to generate an intermediate frequency (IF) or baseband signal. In some embodiments, the down-conversion may be performed by another device coupled to the transceiver. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as in the context of a voice call) or to the main processor 340 for further processing (such as for web browsing data or any number of other applications). The TX processing circuitry 315 receives analog or digital voice data from the microphone 320 or, in other cases, TX processing circuitry 315 may receive other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305. The same operations may be performed using alternative methods and arrangements without departing from the spirit or scope of the present disclosure.

The main processor 340 can include one or more processors or other processing devices and execute the basic OS program 361 stored in the memory 360 to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller. The transceiver 310 coupled to the processor 340, directly or through intervening elements. The main processor 340 is also capable of executing other processes and programs resident in the memory 360, such as CLTM in wireless communication systems as described in embodiments of the present disclosure. The main processor 340 can move data into or out of the memory 360 as required by an executing process. In some embodiments, the main processor 340 is configured to execute the applications 362 based on the OS program 361 or in response to signals received from BSs or an operator of the UE. The main processor 340 is also coupled to the I/O interface 345, which provides the UE 300A with the ability to connect to other devices such as laptop computers and handheld computers. The I/O interface 345 is the communication path between these accessories and the main controller 340. The main processor 340 is also coupled to the keypad 350 and the display unit 355. The operator of the UE 300A can use the keypad 350 to enter data into the UE 300A. The display 355 may be a liquid crystal display or other display capable of rendering text and/or at least limited graphics, such as from web sites. The memory 360 is coupled to the main processor 340. Part of the memory 360 can include a random-access memory (RAM), and another part of the memory 360 can include a Flash memory or other read-only memory (ROM).

The UE 300A of FIG. 3A may also include additional or different types of memory, including dynamic random-access memory (DRAM), non-volatile flash memory, static RAM (SRAM), different levels of cache memory, etc. While the main processor 340 may be a complex-instruction set computer (CISC)-based processor with one or multiple cores, it was noted that in other embodiments, the processor may include a plurality of processors. The processor(s) may also include a reduced instruction set computer (RISC)-based processor. The various other components of UE 300A may include separate processors, or they may be controlled in part or in full by firmware or middleware. For example, any one or more of the components of UE 300A may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the UE 300A may rely on middleware or firmware, updates of which may be received from time to time. For smartphones and other UEs whose objective is typically to be compact, the hardware design may be implemented to reflect this smaller aspect ratio. The antenna(s) may stick out of the device, or in other UEs, the antenna(s) may be implanted in the UE body. The display panel may include a layer of indium tin oxide or a similar compound to enable the display to act as a touchpad. In short, although FIG. 3A illustrates one example of UE 300A, various changes may be made to FIG. 3A without departing from the scope of the disclosure. For example, various components in FIG. 3A can be combined, further subdivided, or omitted and additional components can be added according to particular needs. As one example noted above, the main processor 340 can be divided into multiple processors, such as one or more central processing units (CPUs) and one or more graphics processing units (GPUs). Also, while FIG. 3A may include a UE (e.g., UE 116 in FIG. 1) configured as a mobile telephone or smartphone, UEs can be configured to operate as other types of mobile or stationary devices. For example, UEs may be incorporated in tower desktop computers, tablet computers, notebooks, workstations, and servers.

FIG. 3B shows an example of a BS 300B in accordance with an embodiment. A non-exhaustive example of a BS 300B may be that of BS 102 in FIG. 1. As noted, the terminology BS and gNB may be used interchangeably for purposes of this disclosure. The embodiment of the BS 300B shown in FIG. 3B is for illustration only, and other BSs of FIG. 1 can have the same or similar configuration. However, BSs/gNBs come in a wide variety of configurations, and it should be emphasized that the BS shown in FIG. 3B does not limit the scope of this disclosure to any particular implementation of a BS. For example, BS 101 and BS 103 can include the same or similar structure as BS 102 in FIG. 1 or BS 300B (FIG. 3B), or they may have different structures. As shown in FIG. 3B, the BS 300B includes multiple antennas 370a-370n, multiple corresponding RF transceivers 372a-372n, transmit (TX) processing circuitry 374, and receive (RX) processing circuitry 376. The transceivers 372a-372N are coupled to a processor, directly or through intervening elements. In certain embodiments, one or more of the multiple antennas 370a-370n include 2D antenna arrays. The BS 300B also includes a controller/processor 378 (hereinafter “processor 378”), a memory 380, and a backhaul or network interface 382. The RF transceivers 372a-372n receive, from the antennas 370a-370n, incoming RF signals, such as signals transmitted by UEs or other BSs. The RF transceivers 372a-372n down-convert the incoming respective RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing. The TX processing circuitry 374 receives analog or digital data (such as voice data, web data, e-mail, interactive video game data, or data used in a machine learning program, etc.) from the processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-convert the baseband or IF signals to RF signals that are transmitted via the antennas 370a-370n. It should be noted that the above is descriptive in nature; in actuality not all antennas 370-370n need be simultaneously active.

The processor 378 can include one or more processors or other processing devices that control the overall operation of the BS 300B. For example, the processor 378 can control the reception of forward channel signals and the transmission of reverse channel signals by the RF transceivers 372a-372n, the RX processing circuitry 376, and the TX processing circuitry 374 in accordance with well-known principles. The processor 378 can support additional functions as well, such as more advanced wireless communication functions. For instance, the processor 378 can perform the blind interference sensing (BIS) process, such as performed by a BIS algorithm, and decode the received signal subtracted by the interfering signals. Any of a wide variety of other functions can be supported in the BS 300B by the processor 378. In some embodiments, the processor 378 includes at least one microprocessor or microcontroller, or an array thereof. The processor 378 is also capable of executing programs and other processes resident in the memory 380, such as a basic operating system (OS). The processor 378 is also capable of supporting CLTM in wireless communication systems as described in embodiments of the present disclosure. In some embodiments, the controller/processor 378 supports communications between entities, such as web RTC. The processor 378 can move data into or out of the memory 380 as required by an executing process. A backhaul or network interface 382 allows the BS 300B to communicate with other devices or systems over a backhaul connection or over a network. The interface 382 can support communications over any suitable wired or wireless connection(s). For example, when the BS 300B is implemented as part of a cellular communication system (such as one supporting 5G, 5G-A, LTE, or LTE-A, etc.), the interface 382 can allow the BS 102 (FIG. 1) to communicate with other BSs over a wired or wireless backhaul connection. Referring back to FIG. 3B, the interface 382 can allow the BS 102 to communicate over a wired or wireless local area network or over a wired or wireless connection to a larger network (such as the Internet). The interface 382 includes any suitable structure supporting communications over a wired or wireless connection, such as an Ethernet or RF transceiver. The memory 380 is coupled to the processor 378. Part of the memory 380 can include a RAM, and another part of the memory 380 can include a Flash memory or other ROM. In certain exemplary embodiments, a plurality of instructions, such as a Bispectral Index Algorithm (BIS) may be stored in memory. The plurality of instructions are configured to cause the processor 378 to perform the BIS process and to decode a received signal after subtracting out at least one interfering signal determined by the BIS algorithm.

As described in more detail below, the transmit and receive paths of the BS 102 (implemented in the example of FIG. 3B as BS 300B using the RF transceivers 372a-372n, TX processing circuitry 374, and/or RX processing circuitry 376) support communication with aggregation of frequency division duplex (FDD) cells or time division duplex (TDD) cells, or some combination of both. That is, communications with a plurality of UEs can be accomplished by assigning an uplink of transceiver to a certain frequency and establishing the downlink using a different frequency (FDD). In TDD, the uplink and downlink divisions are accomplished by allotting certain times for uplink transmission to the BS and other times for downlink transmission from the BS to a UE. Although FIG. 3B illustrates one example of a BS 300B which may be similar or equivalent to BS 102 (FIG. 1), various changes may be made to FIG. 3B. For example, the BS 300B can include any number of each component shown in FIG. 3B. As a particular example, an access point can include multiple interfaces 382, and the processor 378 can support routing functions to route data between different network addresses. As another example, while described relative to FIG. 3B for simplicity as including a single instance of TX processing circuitry 374 and a single instance of RX processing circuitry 376, the BS 300B can include multiple instances of each (such as one transmission or receive per RF transceiver).

As an example, Release 13 of the LTE standard supports up to 16 CSI-RS [channel status information-reference signal] antenna ports which enable a BS to be equipped with a large number of antenna elements (such as 64 or 128). In this case, a plurality of antenna elements is mapped onto one CSI-RS port. Furthermore, up to 32 CSI-RS ports are supported in Rel. 14 LTE. For next generation cellular systems such as 5G, the maximum number of CSI-RS ports may be greater. The CSI-RS is a type of reference signal transmitted by the BS to the UE to allow the UE to estimate the downlink radio channel quality. The CSI-RS can be transmitted in any available OFDM symbols and subcarriers as configured in the radio resource control (RRC) message. The UE measures various radio channel qualities (time delay, signal-to-noise ratio, power, etc.) and reports the results to the BS.

The BS 300B of FIG. 3B may also include additional or different types of memory 380, including dynamic random-access memory (DRAM), non-volatile flash memory, static RAM (SRAM), different levels of cache memory, etc. While the main processor 378 may be a complex-instruction set computer (CISC)-based processor with one or multiple cores, in other embodiments, the processor may include a plurality or an array of processors. Often in embodiments, the processing power and requirements of the BS may be much higher than that of the typical UE, although this is not required. Some BSs may include a large structure on a tower or other structure, and their immobility accords them access to fixed power without the need for any local power except backup batteries in a blackout-type event. The processor(s) 378 may also include a reduced instruction set computer (RISC)-based processor or an array thereof. The various other components of BS 300B may include separate processors, or they may be controlled in part or in full by firmware or middleware. For example, any one or more of the components of BS 300B may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the BS 300B may rely on middleware or firmware, updates of which may be received from time to time. In some configurations, the BS may include layers of stacked motherboards to accommodate larger processing needs, and to process channel state information (CSI) and other data received from the UEs in the vicinity.

In short, although FIG. 3B illustrates one example of a BS, various changes may be made to FIG. 3B without departing from the scope of the disclosure. For example, various components in FIG. 3B can be combined, further subdivided, or omitted, and additional components can be added according to particular needs. As one example noted above, the main processor 378 can be divided into multiple processors, such as one or more central processing units (CPUs) and one or more graphics processing units (GPUs)—or in some cases, multiple motherboards for enhanced functionality. The BS may also include substantial solid-state drive (SSD) memory, or magnetic hard disks to retain data for prolonged periods. Also, while one example of BS 300B was that of a structure on a tower, this depiction is exemplary only, and the BS may be present in other forms in accordance with well-known principles.

A description of various aspects of the disclosure is provided below. The text in the written description and corresponding figures are provided solely as examples to aid the reader in understanding the principles of the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

Aspects, features, and advantages of the disclosure are readily apparent from the following detailed description. Several embodiments and implementations are shown for illustrative purposes. The disclosure is also capable of further and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

Although exemplary descriptions and embodiments to follow employ orthogonal frequency division multiplexing (OFDM) or orthogonal frequency division multiple access (OFDMA) for purposes of illustration, other encoding/decoding techniques may be used. That is, this disclosure can be extended to other OFDM-based transmission waveforms or multiple access schemes such as filtered OFDM (F-OFDM). In addition, the principles of this disclosure are equally applicable to different encoding and modulation methods altogether. Examples include LDPC, QPSK, BPSK, QAM, and others.

This present disclosure covers several components which can be used in conjunction or in combination with one another, or which can operate as standalone schemes. Given the sheer volume of terms and vernacular used in conveying concepts relevant to wireless communications, practitioners in the art have formulated numerous acronyms to refer to common elements, components, and processes. For the reader's convenience, a non-exhaustive list of example acronyms is set forth below. As will be apparent in the text that follows, a number of these acronyms below and in the remainder of the document may be newly created by the inventor, while others may currently be familiar. For example, certain acronyms (e.g., CLTM, etc.) may be formulated by the inventors and designed to assist in providing an efficient description of the unique features within the disclosure. A list of both common and unique acronyms follows.

### Abbreviations

L1 Layer 1
L2 Layer 2
L3 Layer 3
UE User Equipment
gNB Base Station
NW Network
NR New Radio
3GPP 3rd Generation Partnership Project
WI Work Item
SI Study Item
HO Handover
CHO Conditional Handover
DAPS Dual Active Protocol Stack
BFD Beam Failure Detection
BFR Beam Failure Recovery
SSB System Synchronization and PBCH Block
CSI Channel State Information
RS Reference Signal
TRP Transmit/Receive Point
PCell Primary Cell
SpCell Special Cell
SCell Secondary Cell
HARQ Hybrid ARQ
NDI New Data Indication
RRC Radio Resource Control
DU Distributed Unit
CU Central Unit
C-RNTI Cell Radio Network Temporary Identifier
CS-RNTI Configured Scheduling Radio Network Temporary Identifier
SPS Semi-Persistent Scheduling
SR Scheduling Request
UL-SCH Uplink Shared Channel
LCP Logical Channel Prioritization
PDU Protocol Data Unit
RSRP Reference Signal Received Power
SINR Signal to Interference and Noise Ratio
BLER Block Error Rate
CQI Channel Quality Indicator
TA Timing Advance
MIB Master Information Block
SIB System Information Block
CORESET Control Resource Set
RAR Random Access Response
DL Downlink
UL Uplink
DCI Downlink Control Information
PDCCH Physical Downlink Control Channel
PUSCH Physical Uplink Shared Channel
PUCCH Physical Uplink Control Channel
PUSCH Physical Downlink Shared Channel
SRS Sounding Reference Signal
PRACH Physical Random Access Channel
IE Information Element
TCI Transmission Configuration Indicator
RA Random Access
RAN Radio Access Network
5GC 5G Core Network
AMF Access Mobility Function
UPF User Plane Function
URLLC Ultra-Reliable Low Latency Communications
PDU Protocol Data Unit
MAC-CE Medium Access Control-Control Element
CFRE Contention-Free Random Access
PDCP Packet Data Convergence Protocol
RLC AM Radio Link Control Acknowledged Mode
DRB Data Radio Bearer
RS Reference Signal
SSB Signal Synchronization Block
CSI-RS Channel State Information Reference Signal
ARFCN Absolute Radio Frequency Channel Number
CLTM Conditional Layer 1/2 Triggered Mobility
SCS Sub-Carrier Spacing
PCI Physical Cell Identifier
RSSI Received Signal Strength Indicator
QCL Quasi Co-Located
BWP Bandwidth Part

The following documents are hereby incorporated by reference in their entirety into the present disclosure as if fully set forth herein: i) 3GPP TS 38.300 v17.5.0; ii) 3GPP TS 38.331 v17.5.0; and iii) 3GPP TS 38.321 v17.5.0.

3GPP (Third-Generation Partnership Project) has developed technical specifications and standards to define the new 5G radio-access technology, known as 5G NR. Mobility handling is a critical aspect in any mobile communication system including 5G system. For a UE in connected mode, mobility is controlled by the network with the assistance from the UE to maintain an optimal connection quality. Based on the measured values of radio link quality of the serving cell and neighboring cell(s) reported by the UE, the network may hand over the UE to a neighboring cell that can provide better radio conditions when the UE is experiencing a degraded connection to the serving cell. The fundamental procedure of network-controlled mobility in connected mode is developed in Releasee 15 NR of 3GPP. Further, in release-16 NR, enhancements to network-controlled mobility in connected mode are introduced to mitigate connection interruption during handover procedure. Specifically, two enhanced handover mechanisms are developed, known as conditional handover (CHO) and dual active protocol stack (DAPS).

Generally, in a CHO procedure, upon receiving CHO configuration in an RRC reconfiguration message which includes configurations for multiple candidate cells, a UE initiates evaluating the CHO execution conditions for the candidate cell(s). If at least one CHO candidate cell satisfies the corresponding CHO execution condition as described in more detail below, the UE detaches from the source cell, applies the configuration of the target cell, and synchronizes to the target cell. The UE thereupon completes the CHO procedure by sending an “RRC reconfiguration complete” message to the new target cell. The UE releases the stored CHO configurations after successful completion of the handover procedure.

More precisely, a CHO is a handover that is executed by the UE when one or more handover execution conditions are met. The UE starts evaluating the execution condition(s) upon receiving the CHO configuration and stops evaluating the execution condition(s) once a handover is executed. The following principles are applicable to a CHO. First, the CHO configuration of a candidate target cell includes the configuration of CHO candidate cell(s) generated by the candidate BS(s) (e.g., gNB) and the execution conditions generated by the source (or serving) BS. An execution condition may include one or two trigger conditions (such as CHO events A3/A5). Only single RS type is supported, and at most two different trigger quantities (e.g. RSRP and RSRQ, RSRP and SINR) can be configured simultaneously for evaluating the CHO execution condition of a single candidate cell.

Further, before any CHO execution condition is satisfied, upon reception of a HO command (that is, without a CHO configuration), the UE executes the HO procedure regardless of any previously received CHO configuration. While executing CHO, or more specifically from the time when the UE starts synchronization with target cell, UE does not monitor the source cell. These principles apply generally to CHOs in existing implementations.

An intra-NR handover is a HO that is performed without the involvement of the 5GC network. As in intra-NR RAN handover and an intra-NR RAN CHOs, the preparation and execution phases of the conditional handover procedure are likewise performed without involvement of the 5GC. Therefore, preparation messages are directly exchanged between base stations (e.g., gNBs). The release of the resources at the source gNB during the CHO completion phase is triggered by the target gNB, rather than the 5GC network.

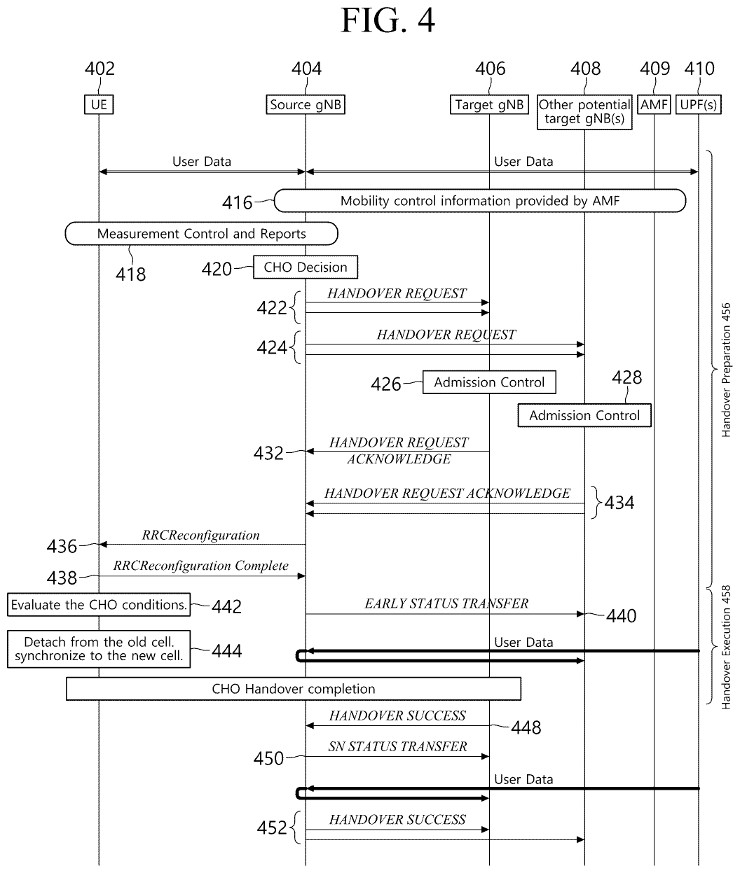

FIG. 4 shows an example signaling diagram 400 of a conditional handover procedure in accordance with an embodiment. Although one or more operations are described or shown in particular sequential order, in other embodiments the operations may be rearranged in a different order, which may include performance of multiple operations in at least partially overlapping time periods. It is noteworthy that in FIG. 4, the basic CHO set of operations is performed where neither the AMF nor the UPF changes. Shown at the top of FIG. 4 are the following devices or functions including UE 402, source gNB 404, target gNB 406, other potential target gNB(s) 408, AMF 409, and UPF 410.

During the handover preparation phase 456, the UE 402 exchanges user data with the source gNB 404, which data is provided to UPF 410

In operation 416, the UE context within the source gNB 404 includes information regarding roaming and access restrictions. This mobility control information is provided either at connection establishment or at the last tracking area update. This information is provided by the AMF 409.

In operation 418, the source gNB 404 configures the UE measurement procedures, and the UE 402 reports its measurements according to the provided measurement configuration.

In operation 420, based on the measurement results received from the UE 402, the source gNB 404 determines that CHO should be used.

In operation 422, the source gNB 404 transmits information requesting participation in a CHO to the target gNB 406. Similarly, in operation 424, the source gNB 404 sends a CHO request to respective potential target gNBs 408. The source gNB 404 transmits a separate CHO request message for each candidate cell corresponding to gNBs 406 and 408.

In operations 426 and 428, admission control procedures may be performed by the target gNBs 406 and other potential target gNB(s) 408. Slice-aware admission control shall be performed if the slice information is sent from the source gNB 404 to the target gNBs 406 and other potential target gNB(s) 408. Network slicing is a technique in which multiple virtual or customized networks are created on top of one shared physical network topology. Each slice can perform a different set of functions relating to a different transmission protocol. These different protocols may help ensure that each slice of the network has its own needed logical topology, together with security rules and performance characteristics specific to that slice. For example, one slice may use ultra-reliable low latency communication (URLLC), which requires high reliability and very low latencies. Other slice types may be directed to a high reliability and not so concerned with real-time communications. If the protocol data unit (PDU) sessions are associated with non-supported slices, the target gNB 406 and other potential target gNB(s) 408 may reject such PDU sessions.

In operation 432, the target gNB 406 sends an acknowledge response (e.g., Handover REQUEST ACKNOWLEDGE) to the source gNB 404. Similarly, in operation 434, each of other potential target gNBs 408 also sends an acknowledgement response to the source gNB 404. The responses sent to the source gNB 404 includes configuration of the CHO candidate cell(s). The CHO response message is sent for each candidate cell corresponding to gNBs 406 and 408.

In operation 436, the source gNB 404 sends an RRC Reconfiguration message to the UE 402. The RRCReconfiguration message includes the configuration of CHO candidate cell(s) and CHO execution condition(s). It should be noted here that the CHO configuration of the candidate cells as discussed above may be followed by other reconfigurations received from the source gNB 404, for example, when the circumstances change (e.g., the speed and trajectory of the UE are changed). It is also noted that a configuration of a CHO candidate cell cannot contain a DAPS handover configuration.

In operation 438, the UE 402 sends an RRCReconfigurationComplete message to the source gNB 404. This message marks the end of the handover preparation phase 456 and the beginning of the handover execution phase 458.

In operation 440, when early data forwarding is applied, the source gNB 404 sends the early status transfer message to the potential target gNB(s) 408. During this time, the UE 402 maintains connection with the source gNB 404 after receiving CHO configuration above. The user data may be forwarded to other potential target gNB(s) 408 before the CHO handover completion.

In operation 442, the UE 402 starts evaluating the CHO execution conditions for the candidate cell(s).

In operation 444, if at least one CHO candidate cell satisfies the corresponding CHO execution condition, the UE 402 detaches from the source gNB 404, applies the stored corresponding configuration for that selected candidate cell, and synchronizes to that candidate cell.

In operation 446, the UE 402 completes the RRC handover procedure by sending RROReconfigurationComplete message to the target gNB 406. The UE 402 releases stored CHO configurations after successful completion of RRC handover procedure. The transmission by the target gNB 406 of CHO completion message 446 marks the end of the HO execution phase 458.

In operation 448, the target gNB 406 transmits a HANDOVER SUCCESS message to the source gNB 404 to inform that the UE 402 has successfully access the target cell.

In operation 450, the source gNB 404 sends the serving network (SN) STATUS TRANSFER message to the target gNB 406. It is noteworthy that late data forwarding to the target gNB 406 may be initiated as soon as the source gNB 404 receives the HANDOVER SUCCESS message.

In operation 452, the source gNB 404 sends the HANDOVER CANCEL messages toward the other signalling connections and the other gNBs that were not targeted in the CHO, which cancels the CHO for the UE 402.

For mobility in connected mode, the conventional handover such as CHO is initiated by the network via higher layer signaling (e.g., RRC message) based on Layer 3 (L3) measurements. However, this procedure involves increased latency, signaling overhead, and interruption time that may become the key issue in some scenarios with frequency handover, for example and without limitation, when the UE is in high-speed vehicular and Frequency Range 2 (FR2) deployment. Therefore, reduction in increased latency, the signaling overhead, and interruption time in handover procedure is needed. As such, a need arises for Layer 1/Layer 2 (L1/L2) Triggered Mobility (LTM), in which handovers can be triggered using L1/L2 signaling based on L1 physical layer measurements. More specifically, LTM may refer to a mobility mechanism whereby the UE switches from the source cell (or serving cell) to a target cell with beam-switching triggered by L1/L2 signaling. The beam switching decision is based on L1 measurements on beams among neighboring cells. Furthermore, the cell switch can be triggered by L1/L2 signaling from the network or triggered by the fulfillment of pre-configured conditional event in conventional LTM (CLTM) procedure.

In LTM procedure, the network may request the UE to perform early timing advance (TA) acquisition of a candidate cell before the cell switch. The early TA acquisition can be triggered by Physical Downlink Control Channel (PDCCH) order or through UE-based TA measurement. The network may indicate in the cell switch command whether the UE shall access the target cell with a random access procedure if a TA value is not provided or with Physical Uplink Shared Channel (PUSCH) transmission using the indicated TA value.

When performing cell switch from the source cell to a target cell in handover operation, the UE needs to acquire TA of the target cell by performing the random access procedure, which introduces delay in the cell switch. To reduce the delay, the UE may autonomously estimate the timing advance for a candidate target cell before performing the cell switch. However, the UE behavior for the UE-based TA measurement (or estimation) in the CHO or the LTM is not yet specified.

As such, this present disclosure provides the UE behavior for UE-based TA measurement. The operation of UE-based TA measurement may be applied in mobility, for example and without limitation, including handover procedure, CHO procedure, conventional LTM procedure, inter-cell multi-Transmit/Receive Point (TRP) operation, Conditional PSCell Addition (CPA)/Conditional PSCell Change (CPC) procedure, CHO procedure with target Secondary Cell Group (SCG), and CHO procedure with target Master Cell group (MCG) and candidates SCGs.

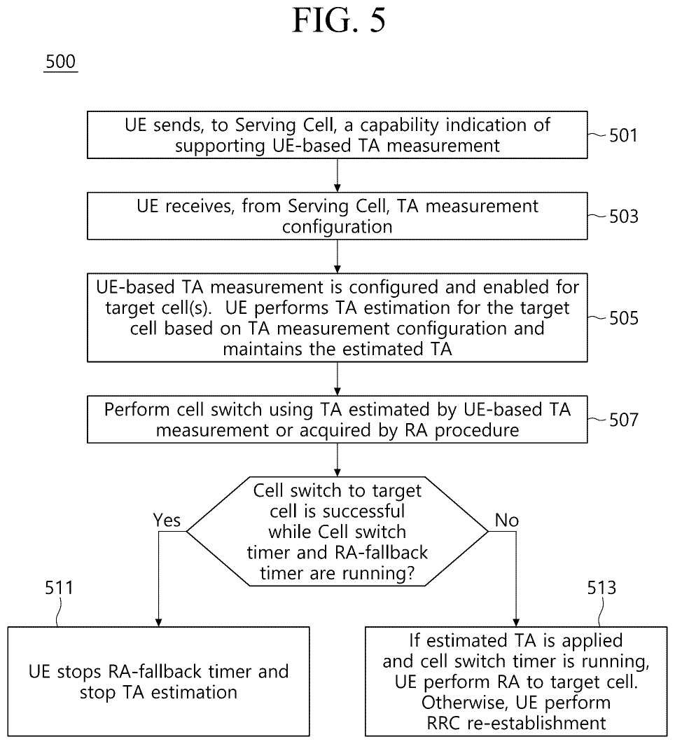

FIG. 5 shows an example process 500 for UE-based timing advance measurement in mobility in accordance with an embodiment. For explanatory and illustration purposes, the example process 500 may be performed by the UE. Although one or more operations are described or shown in particular sequential order, in other embodiments the operations may be rearranged in a different order, which may include performance of multiple operations in at least partially overlapping time periods.

Referring to FIG. 5, the process 500 may begin in operation 501. In operation 501, the UE may send to a serving cell a capability information indicating that the UE supports UE-based TA measurement. In some embodiments, the capability information may indicate that the UE-based TA measurement can be performed per frequency band or per frequency band combination.

In operation 503, the UE may receive from the serving cell a TA measurement configuration (or TA estimation configuration) for a list of target cells when the UE is capable of timing advance measurement. In this disclosure, the target cell for TA estimation may refer to, for example and without limitation, a serving cell (e.g., SCell in a cell group), a target cell of handover operation, a candidate cell for CHO, a candidate cell for LTM, a candidate cell for CLTM, a candidate cell for CHO with target SCG, a candidate cell for CHO with candidate SCGs, a candidate cell for CPA, a candidate cell for CPC, or a non-serving cell for inter-cell or intra-cell multi-TRP operation. The TA measurement configuration may include various information required for estimating the TA in the UE, as illustrated below according to various embodiments.

First, the TA measurement configuration may include a TA estimation enabling indication for one or more target cells. The TA estimation enabling indication may indicate that UE-based TA measurement is enabled for one or more target cells. In other words, the TA estimation enabling indication may indicate that the UE is configured to perform UE-based TA measurement for corresponding target cell(s). In an embodiment, the TA estimation enabling indication may be explicitly indicated for a particular cell. In another embodiment, the TA estimation enabling indication may be intended for more than one target cell or a list of target cells.

The TA measurement configuration may indicate one or more RS resources to be used by the UE for timing advance estimation. For each RS, time and frequency information including, for example and without limitation, periodicity, duration, offset, carrier frequency, and subcarrier spacing, may be provided in the TA measurement configuration. When signal synchronization blocks (SSBs) are used as the RSs for the TA estimation, SSB Measurement Time Configuration (SMTC), SSB periodicity, and/or SSB position in burst (e.g., SSB indexes) can be also provided in the TA measurement configuration. In an embodiment, the RS resources configured for a cell (e.g., for LTM L1 measurement, CSI measurement, and/or radio resource management (RRM)) can be used for the timing advance estimation. In some implementation, a one-bit indication for the timing advance estimation enabling may be included per RS resource such that the RSs included in the RS resource configuration with the timing advance estimation enabled are used for the timing advance estimation in the UE. In another implementation, the RS for the TA estimation may be configured for a cell, which are used dedicated for TA estimation purpose.

The TA measurement configuration may include a reference timing advance for the timing advance estimation of a target cell. In some embodiments, the reference timing advance may be provided by indicating a reference cell, and the timing advance of the reference call may be considered as the reference timing advance. Additionally, a timing advance group (TAG) including the reference cell may be considered as a reference TAG. The TAG includes one or more serving cells with the same uplink timing advance and the same downlink timing reference cell. In an embodiment, for TA estimation of a SCell in a cell group, the SpCell (i.e., PCell for MCG or PSCell for SCG) may be the reference cell by default, without explicit indication of the reference cell. In another embodiment, for TA estimation of a target cell, the reference cell may be explicitly indicated in the TA measurement configuration by including an identity of the reference cell, for instance, PCI or logical ID. In another embodiment, the reference timing advance may be provided by indicating a reference TAG, and the timing advance of the TAG may be considered as the reference timing advance. Then, the cell(s) belonging to the reference TAG are considered as the reference cell(s). In an implementation, for TA estimation of a SCell in a cell group, a primary TAG (PTAG) may be the reference TAG by default, without explicit indication of the reference cell. In another implementation, for TA estimation of a target cell, the reference TAG can be explicitly indicated in the TA measurement configuration by including the identifier of the TAG.

The TA measurement configuration may include one or more parameters to be applied to estimate the timing advance of a target cell. In an embodiment, when downlink timing between a reference cell and a target cell is not synchronized, a timing offset between the downlink timing of the reference cell and the downlink timing of the target cell can be included in the TA measurement configuration. The timing offset may be indicated by, for example and without limitation, an integer number of symbols, slots, subframes, or frames in terms of a reference subcarrier spacing (for example, 15 kHz). In another embodiment, when the timing offset is not configured, the TA measurement configuration may implicitly indicate that the downlink timing between the reference cell and the target cell is synchronized. In an embodiment, when system frame number (SFN) and frame timing difference (SFTD) is supported by the UE and is configured to the UE for the target cell, the UE may perform SFTD to derive the downlink SFN and frame timing difference between a reference cell (e.g., serving cell) and a target cell. In this scenario, if the TA measurement configuration includes an indication that the SFTD is utilized for TA estimation, it can implicitly indicate that the downlink timing between the reference cell and the target cell is not synchronized, and the UE may use the derived DL SFN and frame timing difference between the reference cell and the target cell for TA estimation.

The TA measurement configuration may include an indication about the reference point for the reception of a RS for TA estimation. In an embodiment, the reference point may be an receive (Rx) antenna connector or an Rx antenna. For example, the reference point can be the center location of the radiation region of the Rx antenna or the Rx transceiver array boundary connector.

The TA measurement configuration may include a timing advance estimation timer for each target cell. The timing advance estimation timer may control the validity or applicability of an estimated timing advance. The duration of the timing advance estimation timer may be indicated, for example and without limitation, by an integer of symbols, slots, subframes, frames, or seconds. In an embodiment, the duration of the timer may be indicated as identical to the period for the validity or applicability of the RS for timing advance estimation of the target cell. A start offset of the timing advance estimation timer can be indicated by an integer number of symbols, slots, frames, subframes, or seconds.

In operation 503, the UE may store the TA measurement configuration for each target cell. In an embodiment, the UE may maintain a variable (for example, Var-1) to store the TA measurement configuration. For each entry received from a list of target cells, when Var-1 includes an entry with an ID of a target cell and the entry includes a TA measurement configuration, the UE may replace the existing TA measurement configuration in Var-1 with the newly received TA measurement configuration for the ID of the target cell. When Var-1 does not include an entry with the ID of the target cell, the UE may add a new entry for the ID in the Var-1 and store the received TA measurement configuration for the ID of the target cell.

In operation 505, the UE-based TA measurement is configured and enabled for one or more target cells. Then, the UE performs timing advance measurement for the one or more target cells based on the TA measurement configuration. In some embodiments, the UE measure the RS(s) configured for TA estimation for a target cell and estimate the timing advance of the target cell using the measurement of the RS(s), for example and without limitation, based on the measurement of the reception timing of the RS(s). In some embodiments, when the reference timing advance is valid for a target cell, the UE may measure the RS(s) configured for TA estimation for the target cell and estimate the timing advance of the target cell. Conversely, when the reference timing advance is invalid for the target cell, the UE may pause or stop the measurement of the RS(s) and the timing advance estimation for the target cell. In some embodiments, when the reference timing advance is valid for a target cell, the UE may consider that the estimated timing advance of the target cell is valid and applicable. Conversely, when the reference timing advance is invalid for the target cell, the UE may consider the estimated timing advance of the target cell is invalid or inapplicable. In some embodiments, a valid timing advance may refer to a timing advance for which a timing alignment timer (TAT) is running. On the other hand, an invalid timing advance may be one for which the TAT has expired. The UE may consider that the estimated timing advance of the target cell is associated with the TAG which the reference timing advance is associated with. The UE may also consider that the target cell with the estimated timing advance belongs to the same TAG as the cell with the reference timing advance.

In operation 505, when the UE is configured with TA estimation for a target cell and also have random access resource and configurations for UE-initiated timing acquisition by performing random access to the target cell, the UE may perform either UE-initiated random access for TA acquisition or UE-based TA measurement (or estimation). If the UE is configured with TA estimation by UE for a target cell and also have random access resources and configurations for network-initiated TA acquisition through random access to the target cell, the UE may perform the UE-based TA measurement when the timing advance acquired by the network-initiated random access is invalid or outdated. In some embodiments, when the timing advance of a target cell is invalid and the TA measurement configuration for the target cell is also available, the UE may measure the RS(s) configured for TA estimation for the target cell and estimate TA of the target cell based on the measurement for the RS(s), and update TA of the target cell by the estimated value.

In operation 505, the UE may maintain a timing advance estimation timer that controls the validity and applicability of the estimated timing advance. In some embodiments, when a duration of the timer is configured for a target cell and the UE estimates the timing advance of the target cell based on a valid reference timing advance, the UE starts or re-starts the timer at the end of the symbol or slot at which the RS for TA estimation for the target cell is measured. In some embodiments, when a duration of the timer and the timer start offset are configured for a target cell and the UE estimates the timing advance of the target cell based on a valid reference timing advance, the UE starts or re-starts the timer by an offset after the end of the symbol or the slot at which the RS for TA estimation for the target cell is measured. The value of the offset can be the timer start offset. The timer start offset may be configured or pre-defined integer numbers of symbols, slots, frames, or subframes. In some embodiments, when the timing advance estimation timer is running for an estimated timing advance, the UE may consider the estimated timing advance for the target cell is valid and applicable. Otherwise, the UE may consider that the estimated timing advance for the target cell is invalid or inapplicable. In some embodiments, when the TAT of a reference timing advance is expired, the UE may stop the timer for the estimated timing advance for the target cell which is estimated based on the reference timing advance.

In operation 507, the UE initiates cell switch to the target cell. For example, in LTM procedure, the UE may initiate the cell switch in response to a cell switch command transmitted from the network (e.g., serving cell). When accessing the target cell for cell switch, the UE may use the timing advance estimated based on UE-based TA measurement. In some embodiments, the UE may perform random access if the estimated timing advance for the target cell is not acquired or invalided. If the estimated timing advance for the target cell is acquired and valid, the UE may skip the random access.

In some embodiments, when i) a TAT for a TAG to which the target cell belongs is not running, ii) a valid timing advance acquired by random access or network indication for the target cell is not available, and iii) a timing advance estimated by the UE for the target cell is valid and available, the UE may apply the estimated timing advance when transmitting a uplink message or signal (e.g., PUSCH, PUCCH, SRS, etc.) to the target cell.

In some embodiments, when i) the TAT for the TAG to which the target cell belongs is not running, ii) a valid timing advance for the target cell acquired by random access or indicated by the network is available, and iii) a valid timing advance estimated by the UE for the target cell is also available, the UE may apply i) the timing advance acquired by random access or indicated by network or ii) the estimated timing advance by the UE, depending on the implementations, when transmitting a uplink message or signal (e.g., PUSCH, PUCCH, SRS, etc.) to the target cell.

In some embodiments, when i) the TAT for the TAG to which the target cell belongs is not running, ii) a valid timing advance for the target cell acquired by random access or indicated is available, and iii) a valid timing advance estimated by the UE for the target cell is also available, the UE may apply i) the timing advance acquired by random access or indicated by network or ii) the estimated timing advance by the UE, with a priority when transmitting a uplink message or signal (e.g., PUSCH, PUCCH, SRS, etc.) to the target cell. When initially applying the estimated timing advance for the target cell and the TAT for the target cell is not running, the UE starts the TAT for the TAG to which the target cell belongs in accordance with the TAG configuration.

In operation 507, upon initiating cell switch to the target cell by applying estimated timing advance based on the TA measurement configuration, the UE may start a cell switch timer. When the cell switch timer that controls UE switching from current serving cell to the target cell is running, the UE may start a random access fallback timer for the target cell if the timer is configured upon initially applying the estimated timing advance for the target cell. The random access fallback timer can be pre-configured with a pre-defined timer duration.

In operation 509, the UE determines whether the cell switch to the target cell is successfully completed while both the cell switch timer and the random access fallback timer are running. When the UE successfully switches to the target cell while both timers are running, the process 500 proceeds to operation 511. Otherwise, it proceeds to operation 513.

In operation 511, the UE stops the cell switch timer and the random access-fallback timer. The UE also stops the UE-based TA measurement for the target cell (i.e., current serving cell) and releases the TA measurement configuration for the target cell.

In operation 513, when i) the RA-fallback timer is expired, ii) the cell switch timer is running, and iii) the estimated timing advance for the target cell has been applied when transmitting uplink message or signal to the target cell, the UE initiates random access to the target cell using random access resource and configuration associated with the target cell. If i) the random access to the target cell is completed successfully while the cell switch timer is running, and ii) the timing advance of the target cell is acquired by the random access, the UE may consider the cell switch to the target cell is completed. Further, the UE may stop the cell switch timer and the timing advance estimation for the target cell (i.e., current serving cell) and release the TA measurement configuration for the target cell.

If both the RA-fallback timer and the cell switch timer are expired, the UE may consider the cell switch to the target cell is failed. Then, the UE may perform RRC re-establishment or fast recovery for the cell switch if configured.

In another embodiment in operation 507, upon initiating cell switch to the target cell by applying estimated timing advance based on the TA measurement configuration, the UE may start a cell switch timer. When the UE switches to the target cell successfully while the cell switch timer is running, UE stops the cell switch timer and the timing advance estimation for the target cell (i.e., current serving cell) and release the TA estimation configuration for the target cell. When i) the cell switch timer is expired, ii) the estimated timing advance for the target cell has been applied when transmitting the uplink message or signal to the target cell, iii) random access to the target cell has not been performed while the cell switch timer has been running, and iv) a RA-fallback timer is configured, the UE starts the RA-fallback timer and initiates the random access to the target cell using random access resource and configuration associated with the target cell. If the random access to the target cell is successfully completed while the RA-fallback timer is running and the timing advance of the target cell is acquired by the random access, the UE may consider that the cell switch to the target cell is completed and stop the RA-fallback timer. The UE may also stop the timing advance estimation for the target cell (i.e., current serving cell) and release the TA measurement configuration for the target cell. If the RA-fallback timer is expired, the UE may consider the cell switch to the target cell is failed, and then the UE may perform RRC re-establishment or fast recovery for the cell switch if configured.

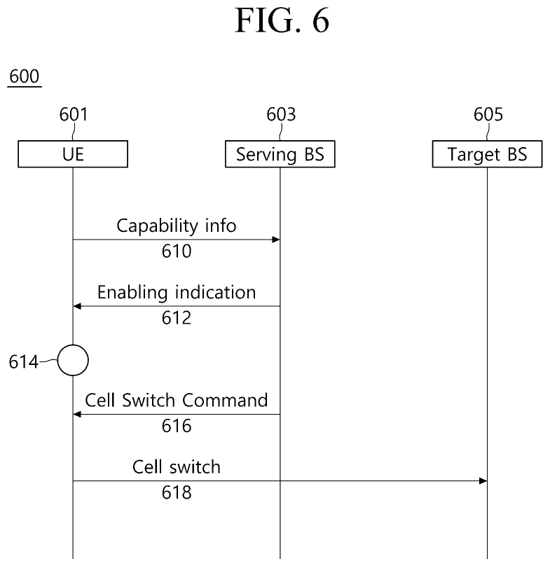

FIG. 6 shows an example process 600 for UE-based timing advance measurement in LTM in accordance with an embodiment. For explanatory and illustration purposes, the example process 600 may be performed among a UE 601, a serving BS 603, and a target BS 605. Although one or more operations are described or shown in particular sequential order, in other embodiments the operations may be rearranged in a different order, which may include performance of multiple operations in at least partially overlapping time periods.

Referring to FIG. 6, the process 600 may begin in operation 610. In operation 610, the UE 601 transmits a capability information to the serving BS 603. The capability information indicates whether the UE supports UE-based TA measurement. In an embodiment, the capability information may indicate whether the UE supports UE-based TA measurement per frequency band.

In operation 612, the serving BS 603 transmits an indication associated with UE-based TA measurement to the UE 601. The indication may indicate that UE-based TA measurement is enabled for the target BS 605 (i.e., a candidate cell for LTM).

In operation 614, upon receiving the indication from the serving BS 603, the UE 601 configures UE-based TA measurement for the target BS 605 for LTM based on the indication. Additionally, the UE 601 performs UE-based TA measurement to measure a TA for LTM.

In operation 616, the serving BS 603 transmits a cell switch command to the UE 601.

In operation 618, upon receiving the cell switch command from the serving BS 603, the UE 601 initiates cell switching to the target BS 605 by applying the measure TA when a valid TA is not included in the cell switch command. When a valid TA is included in the cell switch command, the UE 601 initiates cell switching to the target BS 605 by apply the valid TA. In an embodiment, the UE 601 may skip a random access to the target BS 605 when a valid TA is available. In an embodiment, the UE 601 may perform random access to the target BS 605 for LTM when a valid TA is not available. In an embodiment, the UE 601 may start a time alignment timer associated with a TAG.

Hereinafter, a mechanism for timing advance report is provided with various embodiments. Usually, Air-to-ground (ATG) network refers to in-flight connectivity technique, using ground-based cell towers that send signals up to an aircraft's antennas of onboard ATG terminal. As a plane travels into different sections of airspace, the onboard ATG terminal automatically connects to the cell with the strongest received signal power, similar to how a mobile phone connects on the ground. In this network, a direct radio link will be established between BS on the ground, namely ATG BS, and CPE (customer premise equipment) type UE mounted in the aircraft, namely ATG UE.

In order to assist the network to reduce the guard period overhead for time Division Duplex (TDD) system, the ATG UE can reports timing advance (TA) to the network. Therefore, the signaling of TA report needs to be specified. The TA of an ATG UE can be reported via MAC control element (CE).

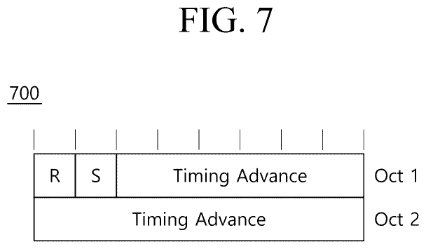

FIG. 7 shows an example of timing advance report MAC CE in accordance with an embodiment. In this example, the TA of an ATG UE can be reported using the conventional TA report MAC CE.

Referring the FIG. 7, the timing advance report MAC CE 700 includes a reserved bit (R), a field(S), and a Timing Advance field. The timing advance report MAC CE 700 has a fixed size and includes two octets. In FIG. 7, R represents a reserved bit and is set to 0. S field is set to 1 when it indicates that the Timing Advance field indicates the number of symbols. This field is set to 0 when it indicates the Timing Advance field indicates the number of slots. When the S field is set to 0, in frequency range 1 (FR 1), the Timing Advance field indicates the least integer number of slots, using subcarrier spacing of 15 kHz, greater than or equal to the Timing Advance value. On the other hand, when the S field is set to 1, the Timing Advance field indicates the least integer number of symbols, for the corresponding subcarrier spacing (e.g., 15 kHz, 30 kHz), greater than or equal to the Timing Advance value. The length of the field in FIG. 7 is 14 bits.

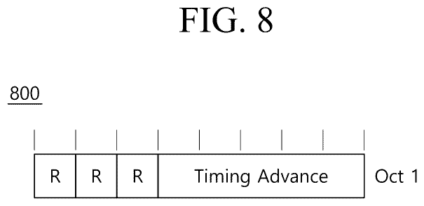

FIG. 8 shows another example of timing advance report MAC CE in accordance with an embodiment. In this example, the TA of an ATG UE can be reported using the new MAC CE.

Referring to FIG. 8, the timing advance report MAC CE 800 may include one or more reserved bits and a Timing Advance field. A new logical channel ID (LCID) or a new extended LCID (eLCID) may be used for the MAC CE 800, which may be referred to as ‘ATG TA report MAC CE’ in this disclosure. The reserved bits (R) may be set to 0. The Timing Advance field indicates the least integer number of symbols, for the corresponding subcarrier spacing (e.g., 15 kHz or 30 kHz), greater than or equal to the Timing Advance value. The length of the field is X bits, where X can be 5, 6, or 7. In the example of FIG. 8, an example of X=5 is shown.

The Timing Advance reporting procedure can be used in a non-terrestrial network and ATG network to provide the base station (e.g., gNB) with an estimate of the UE's Timing Advance value.

The RRC controls Timing Advance reporting by configuring the following parameters:
offsetThresholdTA;
timingAdvanceSR.

A Timing Advance report (TAR) shall be triggered if any of the following events occur:
upon indication from upper layers to trigger a Timing Advance report;
upon configuration of offsetThresholdTA by upper layers, if the UE has not previously reported Timing Advance value to current Serving Cell; or
if the variation between the current estimate of the Timing Advance value and the last reported Timing Advance value is equal to or larger than offsetThresholdTA, if configured.

The MAC entity shall:

| | |
|---|---|
| 1> | if the Timing Advance reporting procedure determines that at least |

one TAR has been triggered and not cancelled:

| | |
|---|---|
| 2> | if UL-SCH resources are available for a new |

transmission and the UL-SCH resources can accommodate the Timing
Advance Report MAC CE plus its subheader as a result of logical
channel prioritization:

| | |
|---|---|
| 3> | instruct the Multiplexing and Assembly |

procedure to generate the Timing Advance Report MAC CE as
defined in clause 6.1.3.56.

| | |
|---|---|
| 2> | else |

| | |
|---|---|
| 3> | if timingAdvanceSR is configured |
| | with value enabled: |

| | |
|---|---|
| 4> | trigger a Scheduling Request. |

In some embodiments, uplink shared channel (UL-SCH) resources are considered available if the MAC entity has been configured with, receives, or determines an uplink grant. If the MAC entity has determined at a given point in time that UL-SCH resources are available, this need not imply that UL-SCH resources are available for use at that point in time.

A MAC PDU shall contain at most one Timing Advance Report MAC CE or one ATG Timing Advance report MAC CE, even when multiple events have triggered a Timing Advance report. The Timing Advance Report MAC CE or ATG Timing Advance report MAC CE shall be generated based on the latest available estimate of the UE's Timing Advance value prior to the MAC PDU assembly.

All triggered Timing Advance reports shall be cancelled when a MAC PDU is transmitted and this PDU includes a Timing Advance Report MAC CE or ATG Timing Advance report MAC CE.

In some embodiments, logical channels shall be prioritised in accordance with the following order (highest priority listed first):
MAC CE for Cell Radio Network Temporary Identifier (C-RNTI), or data from Uplink Common Control Channel (UL-CCCH);
MAC CE for (Enhanced) Beam Failure Recovery (BFR), or MAC CE for Configured Grant Confirmation, or MAC CE for Multiple Entry Configured Grant Confirmation;
MAC CE for Sidelink Configured Grant Confirmation;
MAC CE for Listen Before Talk (LBT) failure;
MAC CE for Timing Advance Report, or MAC CE for ATG Timing Advance Report;
MAC CE for Side link (SL)-Buffer Status Report (BSR)
MAC CE for (Extended) BSR, with exception of BSR included for padding;
MAC CE for (Enhanced) Single Entry Power Headroom Report (PHR), or MAC CE for (Enhanced) Multiple Entry PHR;
MAC CE for Positioning Measurement Gap Activation/Deactivation Request;
MAC CE for the number of Desired Guard Symbols;
MAC CE for Case-6 Timing Request;
MAC CE for (Extended) Pre-emptive BSR;
MAC CE for SL-BSR, with exception of SL-BSR and SL-BSR included for padding;
MAC CE for Integrated Access/Backhaul (IAB)-Mobile Terminal (MT) Recommended Beam Indication, or MAC CE for Desired IAB-MT Power Spectral Density (PSD) range, or MAC CE for Desired DL Tx Power Adjustment;
data from any Logical Channel, except data from UL-CCCH;
MAC CE for Recommended bit rate query;
MAC CE for BSR included for padding;
MAC CE for SL-BSR included for padding.

In some embodiments, prioritization among MAC CEs of same priority is up to UE implementation.

The MAC entity shall prioritize any MAC CE listed in a higher order than ‘data from any Logical Channel, except data from UL-CCCH’ over NR sidelink transmission.

In some embodiments, UE performs RRC release procedure as follows.

| 1> | if the RRCRelease includes suspendConfig: | |
|---|---|---|
| | 2> | reset MAC and release the default MAC Cell Group |
| | | configuration, if any; |
| | 2> | apply the received suspendConfig except the received |

nextHopChainingCount,

| | |
|---|---|
| 2> | if the sdt-Config is configured: |

| | |
|---|---|
| 3> | for each of the DRB in the sdt-DRB-List: |

| | |
|---|---|
| 4> | consider the DRB to be configured for SDT; |

| | |
|---|---|
| 3> | if sdt-SRB2-Indication is configured: |

| | |
|---|---|
| 4> | consider the SRB2 to be configured for SDT; |

| | |
|---|---|
| 3> | for each RLC bearer (except those associated with |

broadcast MRBs and multicast MRBs) that is not suspended:

| | |
|---|---|
| 4> | re-establish the RLC entity; |

| | |
|---|---|
| 3> | for SRB2 (if it is resumed) and for SRB1: |

| | |
|---|---|
| 4> | trigger the PDCP entity to perform |
| | SDU discard; |

| | |
|---|---|
| 3> | if sdt-MAC-PHY-CG-Config is configured: |

| | |
|---|---|
| 4> | configure the PCell with the configured grant |

resources for SDT and instruct the MAC entity to start the
cg-SDT-TimeAlignmentTimer for the PTAG indicated by tag-Id;

In some embodiments, UE handles inactivePosSRS-TimeAlignmentTimer as follows:

| | |
|---|---|
| 1> | when the indication is received from upper layer for starting |

the inactivePosSRS-TimeAlignmentTimer:

2> start or restart the inactivePosSRS-TimeAlignmentTimer;
2> consider the TimeAlignmentTimer associated with the

TAG indicated by tag-Id2, if running, as expired.
In some embodiments, UE handles cg-sdt-TAT as follows:

| | |
|---|---|
| 1> | when instruction from the upper layer has been received for |

starting the cg-SDT-TimeAlignmentTimer;

| | |
|---|---|
| 2> | start the cg-SDT-TimeAlignmentTimer for the indicated |
| | PTAG. |

```
  2> consider the TimeAlignmentTimer associated with the PTAG
indicated by tag-Id2, if running, as expired.
  In some embodiments. UE handles cg-sdt-TAT as follows:
```

| | |
|---|---|
| 1> | when instruction from the upper layer has been received for |

starting the cg-SDT-TimeAlignmentTimer:

| | |
|---|---|
| 2> | apply the N_{TA} value of the indicated PTAG; |
| 2> | start the cg-SDT-TimeAlignmentTimer for |
| | the indicated PTAG. |

In some embodiments. UE handles cg-sdt-TAT as follows:

| | |
|---|---|
| 1> | when instruction from the upper layer has been received for |

starting the cg-SDT-TimeAlignmentTimer:

2> apply the N_{TA} value of the indicated TAG
(e.g., PTAG, STAG);
2> start the cg-SDT-TimeAlignmentTimer for the indicated

TAG (e.g., PTAG, STAG).

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the disclosure. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A user equipment (UE) for facilitating communication in a wireless network, the UE comprising:
a transceiver configured to:
transmit, to a base station (BS), a capability information indicating whether the UE supports UE-based timing advance measurement; and
receive, from the BS, an indication indicating that UE-based timing advance measurement is enabled for a candidate cell for layer 1/layer 2 triggered mobility (LTM), and
a processor configured to the transceiver, the processor configured to:
configure UE-based timing advance measurement for the candidate cell for LTM based on the indication; and
perform UE-based timing advance measurement for the candidate cell for LTM,
wherein the transceiver is further configured to receive, from the BS, a cell switch command, and
wherein the processor is further configured to:
when a valid timing advance is not included in the cell switch command, switch to the candidate cell for LTM by applying a timing advance measured by the UE; and
when the valid timing advance is included in the cell switch command, switch to the candidate cell for LTM by applying the valid timing advance.

2. The UE of claim 1, wherein the processor is further configured to start a time alignment timer associated with a timing advance group.

3. The UE of claim 1, wherein the capability information indicates whether the UE supports UE-based timing advance measurement per frequency band.

4. The UE of claim 1, wherein the processor is further configured to skip random access to switch to the candidate cell for LTM when a valid timing advance is available.

5. The UE of claim 1, wherein the processor is further configured to perform random access to switch to the candidate cell for LTM when a valid timing advance is not available.

6. The UE of claim 1, wherein the transceiver is further configured to receive, from the BS, a reference timing advance for UE-based timing advance measurement.

7. The UE of claim 6, wherein the processor is further configured to:
determine that the timing advance measured by the UE is valid when the reference timing advance is valid; and
determine that the timing advance measured by the UE is invalid when the reference timing advance is invalid.

8. The UE of claim 1, wherein the transceiver is further configured to receive, from the BS, a timing advance estimation timer that controls validity of timing advance estimated based on UE-based timing advance measurement.

9. A method performed by a user equipment (UE) for facilitating wireless communication in a wireless network, comprising:
transmitting, to a base station (BS), a capability information indicating whether the UE supports UE-based timing advance measurement;
receiving, from the BS, an indication indicating that UE-based timing advance measurement is enabled for a candidate cell for layer 1/layer 2 triggered mobility (LTM);
configuring UE-based timing advance measurement for the candidate cell for LTM based on the indication;
performing UE-based timing advance measurement for the candidate cell for LTM;
receiving a cell switch command from the BS;
when a valid timing advance is not included in the cell switch command, switching to the candidate cell for LTM by applying a timing advance measured by the UE; and
when the valid timing advance is included in the cell switch command, switching to the candidate cell for LTE by applying the valid timing advance.

10. The method of claim 9, further comprising starting a time alignment timer associated with a timing advance group.

11. The method of claim 9, wherein the capability information indicates whether the UE supports UE-based timing advance measurement per frequency band.

12. The method of claim 9, further comprising skipping random access to switch to the candidate cell for LTM when a valid timing advance is available.

13. The method of claim 9, further comprising performing random access to switch to the candidate cell for LTM when a valid timing advance is not available.

14. The method of claim 9, further comprising receiving, from the BS, a reference timing advance for UE-based timing advance measurement.

15. The method of claim 14, further comprising:
determining that the timing advance measured by the UE is valid when the reference timing advance is valid; and
determining that the timing advance measured by the UE is invalid when the reference timing advance is invalid.

16. The method of claim 9, further comprising receiving, from the BS, a timing advance estimation timer that controls validity of timing advance estimated based on UE-based timing advance measurement.

17. A base station (BS) facilitating communication in a wireless network, the BS comprising:
a transceiver configured to:
receive, from a user equipment (UE), a capability information indicating whether the UE supports UE-based timing advance measurement;
transmit, to the UE, an indication indicating that UE-based timing advance measurement is enabled for a candidate cell for layer 1/layer 2 triggered mobility (LTM); and
transmit, to the UE, a cell switch command that triggers cell switching to the candidate cell for LTM.

18. The BS of claim 17, wherein no valid timing advance in the cell switch command indicates that a timing advance measured by the UE is applied to switch to the candidate cell for LTM.

19. The BS of claim 17, wherein the capability information indicates whether the UE supports UE-based timing advance measurement per frequency band.

20. The BS of claim 17, wherein the transceiver is further configured to transmit, to the UE, i) a reference timing advance for UE-based timing advance measurement and ii) a timing advance estimation timer that controls validity of timing advance estimated based on UE-based timing advance measurement.
